(19) United States
(12) Patent Application Publication
(10) Pub. No.: US 2014/0051492 A1
(43) Pub. Date: Feb. 20, 2014

(54) SYSTEM AND METHOD FOR ALLOWING PLAYERS TO PLAY ROULETTE GAMES HAVING MODIFIABLE WAGERS

(71) Applicant: ONEworks IP Holdings Limited, Road Town (VG)

(72) Inventor: Chan Guan Koh, Singapore (SG)

(73) Assignee: ONEworks IP Holdings Limited, Road Town (VG)

(21) Appl. No.: 13/971,617

(22) Filed: Aug. 20, 2013

Related U.S. Application Data
(60) Provisional application No. 61/684,842, filed on Aug. 20, 2012.

(51) Int. Cl. G07F 17/32

(52) U.S. Cl. CPC G07F 17/3244
USPC 463/17

(57) ABSTRACT

A method for allowing players to play a matching-type game with a gaming device is described. The method includes the steps of displaying a matching-type game that includes a plurality of game symbols being displayed on a game screen. Each game symbol indicative of a plurality of game outcomes. The method includes receiving a request from a player to place a wager on the game, the wager being associated with a first outcome and a second outcome, responsively generating a modified wager as a function of the received request, randomly generating an outcome of the matching-type game, and resolving the modified wager as a function of the first outcome, the second outcome, and the generated game outcome.

### CROSS REFERENCE TO RELATED APPLICATION

This application claims the benefit of U.S. Provisional Patent Application Ser. No. 61/684,842, filed Aug. 20, 2012, the disclosure of which is hereby incorporated by reference in its entirety for all purposes.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The subject matter disclosed herein relates generally to a system for allowing players to play matching-type games and more particularly, to methods and systems for allowing players to play roulette-type games that include modifiable wagers and a winning condition that is determined as a function of a first game outcome and a second game outcome.

### BACKGROUND OF THE INVENTION

At least some known gaming systems display video based games such as roulette-type games that allow players to place wagers on the outcome of the game. During play of the roulette-type games, the gaming system allows players to place wagers on game outcomes associated with symbols being displayed on a roulette wheel, generates a game outcome, rotates the roulette wheel, and spins a ball within the roulette wheel until the ball lands or stops of one of the symbols being displayed in the roulette wheel. The gaming system then compares the players' wagered outcome with the generated game outcome and provides the players an award if the generated outcome matches the wagered outcome. At least some known gaming systems allow players a predefined period of time prior to spinning the roulette wheel in which to place all wagers.

Over time, during game play, a player may become frustrated because the chances of receiving an award are based only on the number of matches made between the symbols associated with the wagers and the generated outcome. In addition, the player may become frustrated because the player is not allowed to modify a wager after the predetermined period of time has elapsed. Accordingly, new features are necessary to increase the wagering opportunities available to the player and to increase a probability of a player achieving a winning outcome to appeal to player interest and enhance excitement in order to entice longer play and increased profitability. The present invention is directed to satisfying these needs.

### SUMMARY OF THE INVENTION

The invention is generally directed to systems and methods for allowing players to play roulette-type games having modifiable wagers that allow a player to modify existing wagers to increase a probability of achieving a winning outcome.

In one aspect of the invention, a method for allowing players to play a matching-type game with a gaming device is provided. The method includes the steps of displaying a matching-type game that includes a plurality of game symbols being displayed on a game screen. Each game symbol being indicative of a plurality of game outcomes. The method includes receiving a request from a player to place a wager on the game, the wager being associated with a first outcome and a second outcome, responsively generating a modified wager as a function of the received request, randomly generating an outcome of the matching-type game, and resolving the modified wager as a function of the first outcome, the second outcome, and the generated game outcome.

In another aspect of the invention, a gaming device for allowing a player to play a matching-type game is provided. The gaming device includes a display device, a user input device, and a controller in communication with the display device and the user input device. The display device displays the matching-type game including a plurality of game symbols being displayed on a game screen. The user input device is adapted to receive a signal indicative of a player's selection. The controller is configured to receive a request from a player to place a wager associated with the game. The wager being associated with a first game outcome and a second game outcome. The controller responsively generates a modified wager as a function of the received request, randomly generates an outcome of the matching-type game, and resolves the modified wager as a function of the first outcome, the second outcome, and the generated game outcome.

In yet another aspect of the invention, one or more non-transitory computer-readable storage media, having computer-executable instructions embodied thereon is provided. The computer-executable instructions, when executed by at least one processor, cause the processor to display a roulette-type game that includes a plurality of game symbols being displayed on a game screen, receive a request from a player to place a wager on the game, the wager being associated with a first outcome and a second outcome, responsively generate a modified wager as a function of the received request, randomly generate an outcome of the roulette-type game, and resolve the modified wager as a function of the first outcome, the second outcome, and the generated game outcome.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system for allowing a player to play a roulette-type game via a user computing device, according to an embodiment of the invention;

FIG. 2 is schematic view of a gaming controller that may be used with the system shown in FIG. 1;

FIG. 3 is a flowchart of a method that may be used with the system shown in FIG. 1 for allowing a player to play a game via a user computing device, according to an embodiment of the invention;

FIGS. 4-6 are exemplary entertaining graphical displays of a roulette-type game that may be used with the method shown in FIG. 3, according to an embodiment of the present invention;

FIG. 7 is an exemplary entertaining graphical display of a broadcast image of a live roulette table that may be used with the method shown in FIG. 3, according to an embodiment of the present invention;

FIG. 8 is a schematic representation of a gaming device for allowing a player to play the roulette-type game shown in FIGS. 4-7, according to an embodiment of the invention;

FIG. 9 is a schematic representation of a gaming machine for allowing a player to play the roulette-type game shown in FIGS. 4-7, according to an embodiment of the invention;

FIG. 10 is another schematic view of the gaming machine shown in FIG. 9;

FIGS. 11 and 12 are a schematic views of another system for allowing a player to play a roulette-type game, according to an embodiment of the invention; and

Corresponding reference characters indicate corresponding parts throughout the drawings.

### DETAILED DESCRIPTION OF THE PREFERRED EMBODIMENT

The exemplary embodiments herein relate to matching-type games. It should be understood that each of the methods and individual steps recited herein may be partially or wholly carried out in a variety of ways and/or systems, which may include, but are not limited to, a live dealer physically operating a roulette wheel coupled to a gaming table displaying a betting area, an electronic gaming machine (EGM) for use by one or more players, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve wagering, the generation of random data, the application of randomly-generated data to predefined rules, the determination of wager outcomes in accordance with preset outcome determining criteria, the notification of such outcomes, awarding of payouts and collecting of wagers. The generation of random data may be facilitated by computerized and/or physical implements. The transformative events may also include parsing of the data for comparative purposes with preset criteria to determine an outcome in a second, bonus or associated wagering game.

With reference to the drawings and in operation, the invention overcomes at least some of the disadvantages of known systems by providing, among other things, systems and methods which enable a player to play a matching-type game that allows the player to place a wager having a payout that is determined as a function of a plurality of possible game outcomes. More specifically, the systems and methods display a roulette-type game including a plurality of game symbols. Each game symbol is indicative of a plurality of game outcomes. The system receives a request from a player to place a wager on the roulette-type game that is associated with a first outcome and a second outcome, randomly generates an outcome of the game, and resolves the player's wager as a function of the first outcome, the second outcome, and the generated game outcome. More specifically, the system provides a penalty to the player if the generated outcome matches the first outcome and provides an award to the player if the generated game outcome matches the second outcome. For example, the system may allow a player to place a bet on a first outcome of the roulette-type game and allow the player to move the placed bet to a second outcome of the roulette-type game. In addition, the system may provide an enhanced award to the player if the second outcome, e.g. the moved bet, is a winning bet, and deduct a penalty from the player if the first outcome, e.g. the placed bet, is a winning outcome. Thus both the risk of losing and the reward of winning on a moved bet is significantly increased over known roulette-type games.

By providing a gaming device and method that generates a wager that is dependant on a plurality of game outcomes, the probability of achieving an award is increased and the burden imposed on game designers is significantly reduced. In addition, by generating a pool of primary wagers and displaying each of the primary wagers on a game screen, the player can more easily view the available wagering options over known gaming systems. Thus, the player's expectation of achieving a winning outcome is increased and the amount of time that the game is played by the patrons of a gaming establishment is thereby increased, thus increasing an overall profitability of the gaming establishment and reducing the burden on the game designers.

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

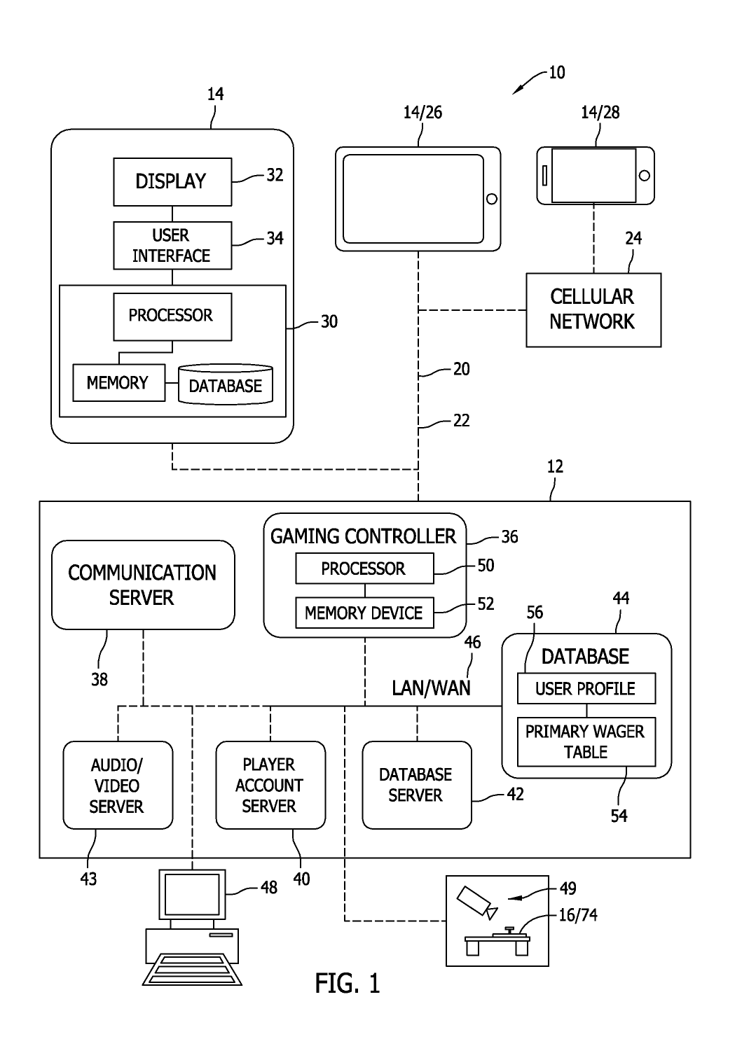

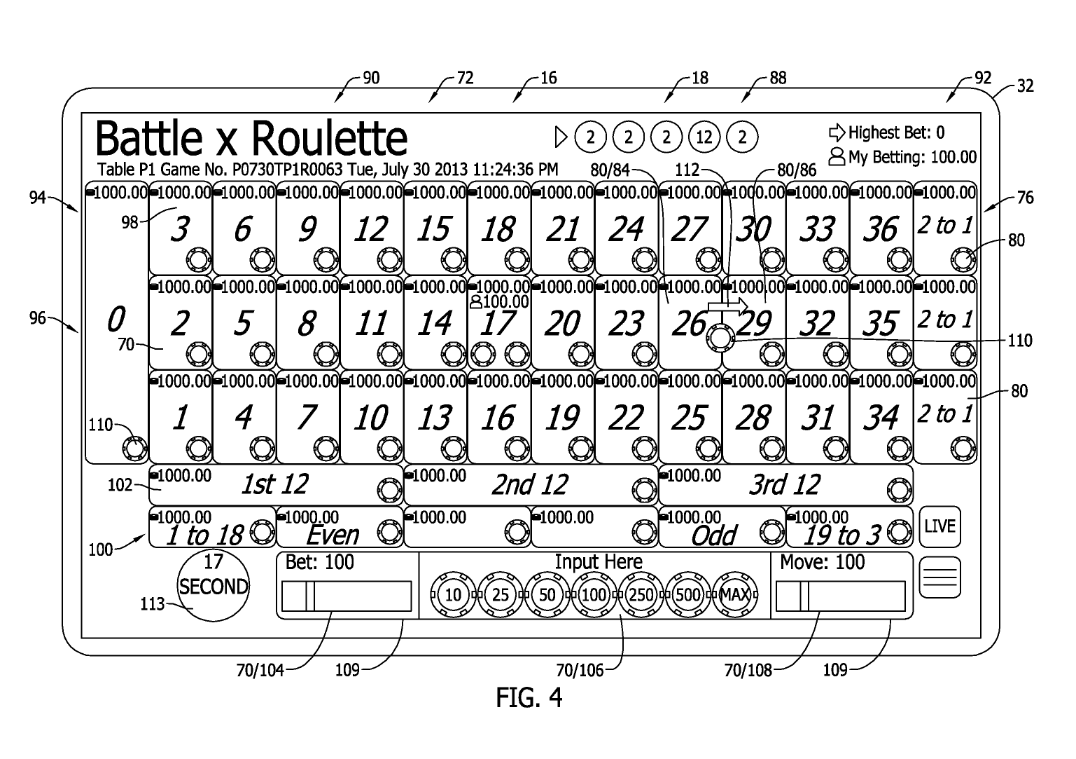

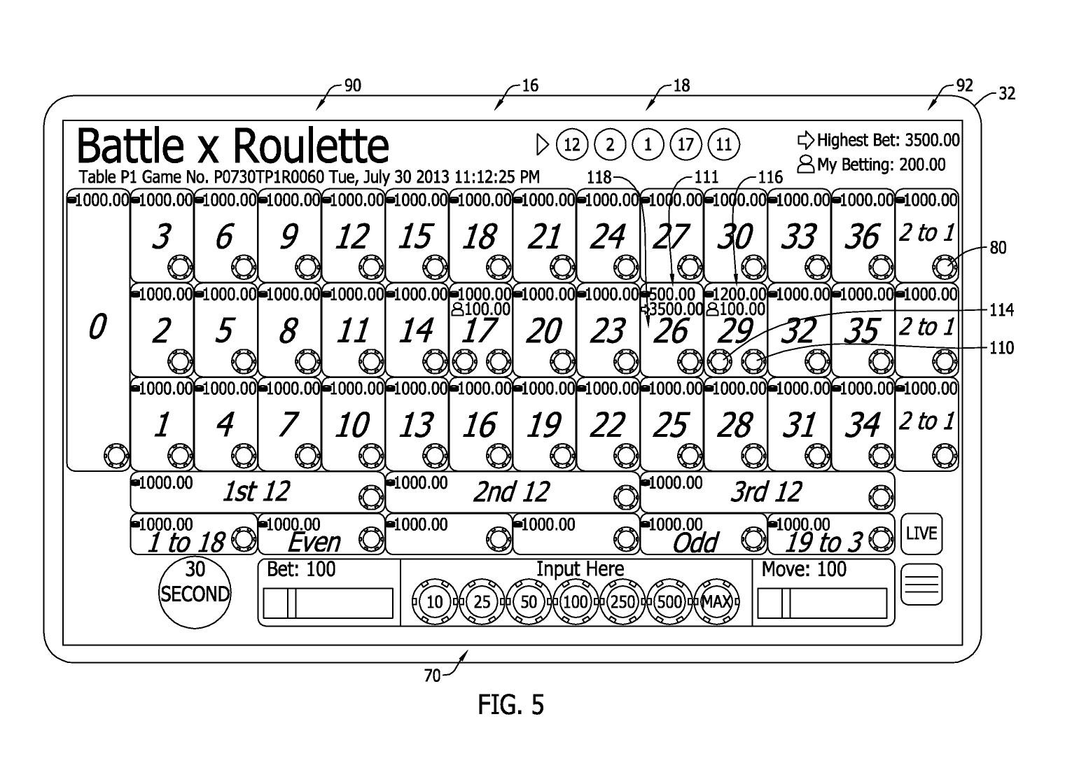

FIG. 1 is a schematic representation of the system 10, according to an embodiment of the invention. In the illustrated embodiment, the system 10 includes a server system 12 that is coupled to one or more user computing devices 14. Each user computing device 14 is configured to transmit and receive data to and/or from the server system 12 to display a game 16 and graphical interfaces 18 (shown in FIGS. 4-7) to enable a user to participate in matching-type games with the user computing device 14. In the illustrated embodiment, the server system 12 is coupled to each user computing device 14 via a communications link 20 that enables each user computing device 14 to access server system 12 over a network 22 such as, for example, the Internet, a cellular telecommunications network 24, a wireless network and/or any suitable telecommunication network that enables the user computing devices 14 to access the server system 12. For example, in one embodiment, the user computing device 14 includes a mobile computing device 26, e.g. a smartphone 28 that communicates with the server system 12 via the cellular telecommunications network 24 and/or the Internet. In another embodiment, the user computing device 14 may include a personal computer, laptop, cell phone, tablet computer, smartphone/tablet computer hybrid, personal data assistant, and/or any suitable computing device that enables a user to connect to the server system 12 and display the graphical interfaces 18.

In the illustrated embodiment, each user computing device 14 includes a controller 30 that is coupled to a display device 32 and a user input device 34. The controller 30 receives and transmits information to and from the server system 12 and displays the game 16 and the graphical interfaces 18 (shown in FIGS. 4-7) on the display device 32 to enable the user to interact with the server system 12 to play the games in accordance with the embodiments described herein. The display device 32 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 34 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the controller 30 and/or to retrieve data from the controller 30. Alternatively, a single component, such as a touch screen, a capacitive touch screen, and/or a touchless screen, may function as both the display device 32 and as the user input device 34.

In the illustrated embodiment, the server system 12 includes a gaming controller 36, a communications server 38, a player account server 40, a database server 42, an audio/video server 43, and a database 44. The servers 38, 40, 42, and 43, gaming controller 36, and database 44 are connected through a network 46 such as, for example, a local area network (LAN), a wide area network (WAN), dial-in-connections, cable modems, wireless modems, and/or special high-speed Integrated Services Digital Network (ISDN) lines. Moreover, at least one administrator workstation 48 is also connected to the network 46 to enable communication with the server system 12.

The communications server 38 communicates with the user computing devices 14 and the administrator workstation 48 to facilitate transmitting data over the network 22 via the Internet and/or the cellular network 24, respectively.

The database server 42 is connected to the database 44 to facilitate transmitting data to and from the database 44. The database 44 contains information on a variety of matters, such as, for example, account information related to a user, user profile information, a game type, a number of game symbols associated with a game, a number of game outcomes, a payout value associated with each game outcome, wagers, wager amounts, wager types, average wagers per game, and image data for producing game images and/or screens on the user computing device 14 and temporarily stores variables, parameters, and the like that are used by the gaming controller 36. In one embodiment, the database 44 includes a centralized database that is stored on the server system 12 and is accessed directly via the user computing devices 14. In an alternative embodiment, the database 44 is stored remotely from the server system 12 and may be non-centralized.

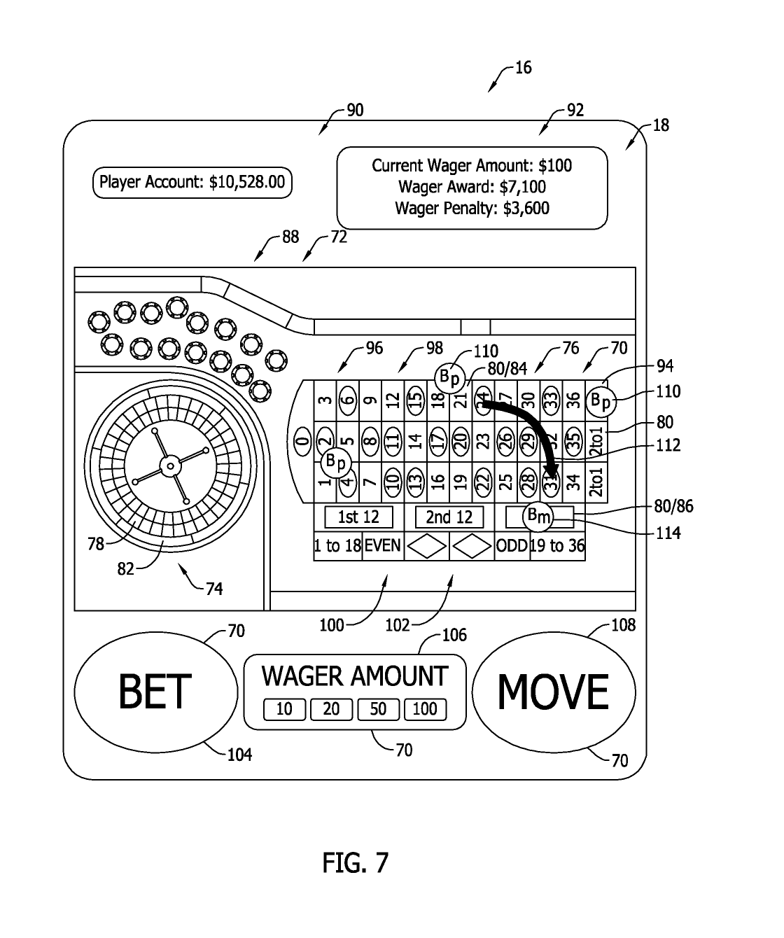

The audio/video server 43 is configured to broadcast images of a live roulette-type game to the user computing devices 14 to allow players to view streaming video images of a live roulette game being played in a casino gaming property. In the illustrated embodiment, the audio/video server 43 is connected to an image broadcast system 49 that is configured to generate video images of a live roulette table game 16 being played in a casino. In one embodiment, the image broadcast system 49 includes a video camera that is configured to capture and transmit images of a live roulette game. The audio/video server 43 is configured to receive and record the images from the image broadcast system 49 and transmit the images to the user computing devices 14. For example, in one embodiment, the server system 12 is configured to broadcast an image of a roulette table including a roulette wheel (shown in FIG. 7) to display the outcome of the roulette game 16 to the players. In one embodiment, the administrative workstation 48 may be connected to a game server (not shown) that is positioned in a casino for receiving data indicative of the outcome of each live roulette game being broadcast by the audio/video server 43. For example, in one embodiment, the workstation 48 may receive data indicative of the game outcome from the casino game server and transmit the game outcome data to the gaming controller 36 for resolving the placed wagers based on the received game outcome. In addition, the audio/video server 43 may delay the broadcast of the live table roulette game for a predefined period of time, and/or broadcast a prerecorded live table roulette game associated with a game outcome determined by the gaming controller 36.

The gaming controller 36 includes a processor 50 and a memory device 52 that is coupled to the processor 50. The memory device 52 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 50 to store, retrieve, and/or execute instructions and/or data.

The processor 50 executes various programs, and thereby controls other components of the server system 12 and the user computing device 14 according to user instructions and data received from the user computing devices 14. The processor 50 in particular displays the graphical interfaces 18 (shown in FIGS. 4-7) and executes a game program, and thereby enables the system 10 to generate games and allow the user to play the games in response to user instructions received via the user computing devices 14 in accordance with the embodiments described herein. The memory device 52 stores programs and information used by the processor 50. Moreover, the memory device 52 stores and retrieves information in the database 44 including, but not limited to, image data for producing images and/or screens on the display device 32, and temporarily stores variables, parameters, and the like that are used by the processor 50. In addition, the memory device 52 may store a primary wager selection table 54 that includes a list of player initiated wagers that are being placed on a plurality of game outcomes during one or more rounds of the game. The primary wager selection table 54 may also include a plurality of player initiated wagers that each include a corresponding game outcome and a wager amount associated with the game outcome.

In the illustrated embodiment, the gaming controller 36 includes multiple instances of the game 16 such that each user computing device 14 may play a separate instance of the game 16 simultaneously. In addition, the gaming controller 36 enables players on one or more user computing devices 14 to simultaneously play the same game.

In the illustrated embodiment, the player account server 40 stores information associated with a plurality of user profile accounts and a plurality of corresponding unique user identifiers in a user profile program 56 in the database 44. In the illustrated embodiment, the player account server 40 uses the unique user identifier to identify the user profile account associated with the unique user identifier and provide the user access to the server system 12 to imitate a gaming session via a user computing device 14. In one embodiment, the unique user identifier may include a combination of a username and password. Alternatively, in another embodiment, the unique user identifier may include a personal identification number, or a random identification number assigned to a corresponding user account. For example, in one embodiment, the unique user identifier may include a mobile device identifier, such as, for example, a cellular phone number and/or wireless internet address for identifying a user computing device 14 associated with a user account.

In one embodiment, each user profile account may include personal identification information such as, for example, a user name, address, personal identification number, date of birth, email address, mobile phone number, and/or any suitable information that enables the player account server 40 to identify a user. In addition, the user profile account may include a player account including player tracking information such as, for example, a type of game previously played by the player, a frequency in which the player plays a game, a number of wagers made during a round of a game, the average number of games played over a predefined period of time, the average credit wager the player makes per play of a game, a total amount wagered by the player over a predefined period of time, and/or any other suitable player tracking information.

In the illustrated embodiment, each user profile account also includes financial account information associated with each user. The financial account information may include, but is limited to, an amount of game credits available for use in playing games, available monetary funds for use in purchasing game credits, an available game credit account balance, and/or any suitable financial information that enables the system 10 to function as described herein.

In the illustrated embodiment, the workstation 48 includes a display and user input device to enable an administrative user to access the server system 12 to transmit data indicative of the game and/or awards to the database server 42. This enables an administrative user to periodically update the game list, game types, wager types, available awards, user profile accounts, and/or any suitable data and information that enables the system 10 to function as described herein.

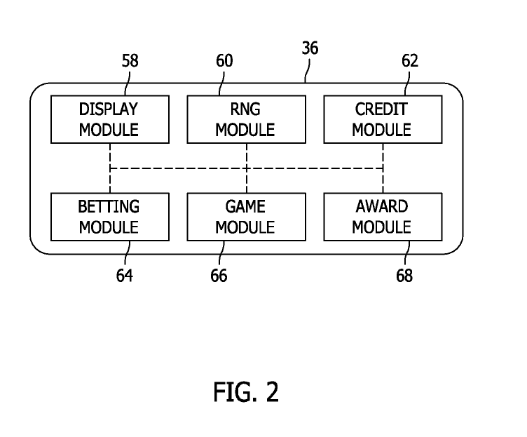

FIG. 2 is schematic view of the gaming controller 36. In the illustrated embodiment, the gaming controller 36 includes a display module 58, a random-number generator (RNG) module 60, a credit module 62, a betting module 64, a game module 66, and an award module 68.

The display module 58 controls the display device 32 to display various images on the graphical interface 18 preferably by using computer graphics and image data stored in the database 44. More specifically, the display module 58 controls the symbols being displayed in a game such as, for example, a roulette-type game 16 (shown in FIGS. 4-6) on the display device 32 by using computer graphics and the image data. In the illustrated embodiment, the display module 58 also displays a plurality of user selection areas 70 (shown in FIGS. 4-6) within the graphical interface 18 that correspond to specific operations that may be initiated by the user. In one embodiment, the display module 58 is configured to display a broadcast live roulette game being played in a casino property. For example, the display module 58 may display the game 16 including a game display area 72 including a broadcast image of a live roulette wheel 74 (shown in FIG. 7) and a betting area 76. For example, the display module 58 may receive video images of the roulette wheel 74 from the audio/video server 43 and display the received images in the game display area 72. In another embodiment, the display module 58 may generate a video image of the roulette wheel 74 from images stored in the database 44. For example, the display module 58 may display the roulette wheel 74 including a plurality of outcome symbols 78, (numbers 1-36 and 0), orientated about a perimeter of the roulette wheel 74. Each outcome symbol 78 is indicative of one of a plurality of game outcomes associated with the game 16. The betting area 76 includes a plurality of game symbols 80 that are indicative of one or more outcome symbols 78. Each game symbol 80 is also indicative of a payout value associated with the corresponding game symbol 80. The payout value is indicative of a probability or odds of the associated game outcome being selected during a round of a game. Each game symbol 80 includes an associated selection area 70 to enable the user to select each displayed game symbol 80 to indicate a user's selection of the corresponding game symbol 80. Each of the selection areas 70 may receive a user selection input via the user input device 34.

The credit module 62 communicates with the player account server 40 to manage the amount of player's credits available for use in playing the roulette-type game 16. The credit module 62 receives a user selection indicative of a request from a user computing device 14 to place one or more wagers on the game 16 including an amount of game credits associated with each wager. The credit module 62 sends a verification message to the player account server 40 including a unique user identifier and a game credit amount associated with the requested wagers. The player account server 40 identifies the user profile account associated with the unique user identifier and determines if sufficient game credits are available in the user profile account as a function of the user request. If the player account server 40 determines sufficient game credits are available in the user profile account, the player account server 40 sends a verification message to the credit module 62 and withholds a corresponding amount of game credits from the user profile account. If the player account server 40 determines that the user profile account does not include a sufficient amount of game credits, the display module 58 displays a message on the user computing device 14 requesting the user to purchase additional game credits corresponding to the request. In addition, the display module 58 may also display an amount of game credits included in the user profile account that are available for use in playing and/or wagering on the games.

The game module 66 includes a game program for use in playing a game based on user selection input receive from a user computing device 14. The game module 66 receives game information included in the database 44 and performs various functions and calculations to play the game according to a set of predetermined game rules and player input. More specifically, the game module 66 retrieves game elements from the database 44 and causes the display module 58 to display the game 16 on the display device 32. The game module 66 receives signals indicative of s user selection input via the user input device 34 and generates an outcome of the game 16 based on the predetermined game rules and the received user selection input, and displays the game outcome on the display device 32.

The RNG module 60 generates and outputs random numbers to the game module 66 for use in playing the game 16. In addition, the game module 66 may use random numbers generated by the RNG module 60 to determine if a winning condition has occurred in the outcome of the game, and to determine whether or not to provide an award to a player. For example, if the game is the roulette-type game 16, the game module 66 uses the RNG module 60 to randomly select one or more outcome symbols 78 indicative of an outcome of the game 16. The game module 66 compares the randomly selected outcome symbol 78 with the game symbols 80 associated with each wager to determine a number of wagered game symbols 80 matching the randomly selected outcome symbols 78.

In the illustrated embodiment, the betting module 64 receives a user selection input from the input device 34 indicative of a wager being placed by the player on the game 16, selects game symbols 80 based on the player's selection, and displays a notification indicative of the player's selection on the graphical interface 18. In addition, the betting module 64 transmits the player's selection to the game module 66 for use in determining if a player's selected game symbol matches a selected outcome symbol 78. During each round of the game 16, the betting module 64 also stores each wager associated with the game round in the database 44 and generates the list of primary wagers stored in the primary wager selection table 54. For each round of the game 16, the betting module 64 generates a list of primary wagers such that the primary wager selection table 54 includes a list of primary wagers associated with each round.

In the illustrated embodiment, the game module 66 determines an outcome of the roulette-type game 16 including any determined symbol matches and transmits the game outcome to the award module 68. The award module 68 compares the game outcome with winning combinations stored in a winning combination table to determine if the symbol matches include a winning outcome that is associated with a type of award. In addition, the award module 68 may compare the game outcome with each received wager to determine if an award and/or a penalty is provided to a player as a function of the game outcome and the corresponding wager.

Each roulette game 16 is generally played in a conventional manner. The player makes a wager, which may be based on a predetermined denomination and a selected one or more game symbols 80. The game module 66 randomly generates an outcome for the game 16, rotates the roulette wheel 74, and spins and stops a ball 82 within the roulette wheel 74 to indicate an outcome symbol 78 associated with the generated game outcome. If the selected game symbols 80 match the selected outcome symbol 78, the player may be awarded a payout based on the selected game symbols 80, the outcome symbol 78, the wager, and a predetermined paytable. Many variations to the above described general play of a roulette-type game fall within the scope of the present invention. Such roulette-type games are well-known in the art, and are therefore not further discussed.

In the illustrated embodiment, the gaming controller 36 allows a player to make a wager that is associated with a first game outcome and a second game outcome, and resolves the wager as a function of the first game outcome, the second game outcome, and a determined game outcome. For example, in one embodiment, the gaming controller 36 allows a player to place a bet on the first game outcome, i.e. a “placed” bet, and allows the player to move the placed bet to a second game outcome, i.e. a “moved” bet. The gaming controller 36 determines the outcome of the game, and resolves the moved bet based on the game outcome and the first and second wagered game outcomes. If the moved bet is the winning bet, the gaming controller 36 provides the player an enhanced award. If the placed bet is the winning bet, the gaming controller 36 deducts a penalty from the player. If neither the placed bet or the moved bet are winning outcomes, the gaming controller 36 retains the wager made on the placed and/or moved bet. In another embodiment, the gaming controller 36 receives a request from a player to place a wager including a player's selection of a first game symbol 84 and a second game symbol 86 and generates the selected wager within the betting module 64 as a function of the received request. The gaming controller 36 randomly generates an outcome 88 of the game 16 and displays the randomly generated game outcome 88 using the roulette wheel 74. More specifically, the gaming controller 36 rotates the roulette wheel 74 and the associated ball 82 and stops the rotation of the ball 82 with the ball 82 positioned with respect to an outcome symbol 78 that is indicative of the generated game outcome 88. In one embodiment, the gaming controller 36 may receive data indicative of an outcome of a live roulette game being played in a gaming property and determine the game outcome as a function of the received data. For example, in one embodiment, the gaming controller 36 may receive the game outcome data from the workstation 48 and/or the game server located at a casino property.

In the illustrated embodiment, the gaming controller 36 then compares the outcome symbol 78 with the selected first game symbol 84 and the selected second game symbol 86, and resolves the player's wager as function of the selected outcome symbol 78, the first game symbol 84, and the second game symbol 86. Moreover, the gaming controller 36 assess the player a penalty if the outcome symbol 78 matches the first game symbol 84 and provides an award to the player if the outcome symbol 78 matches the second game symbol 86. For example, in one embodiment, the gaming controller 36 may determine the penalty being equal to the wager value in game credits multiplied by the payout value associated with the first game symbol 84. The gaming controller 36 may also determine the award being equal to the wager value multiplied by the payout value associated with the second game symbol 86. In addition, the gaming controller 36 may provide a primary award and an enhanced award to the player if the outcome symbol 78 matches the second game symbol 86. For example, the gaming controller 36 may determine the primary award being equal to the wager value multiplied by the second game symbol payout value and the enhanced award being equal to the wager value plus the wager multiplied by the second symbol payout value. Thus, by placing a wager associated with the first and second game outcomes the player has an increased chance of receiving a larger award as compared to a wager associated with a single game outcome. In general, the term “award” may be a payout, in terms of credits or money. Thus, the gaming controller 36 may award a regular payout in response to the outcome of the roulette-type game 16. However, it should be noted that the term award may also refer to other types of awards, including, prizes, e.g., meals, show tickets, etc. . . . , as well as in-game award, such as free games, bonus symbols, and/or special game modes.

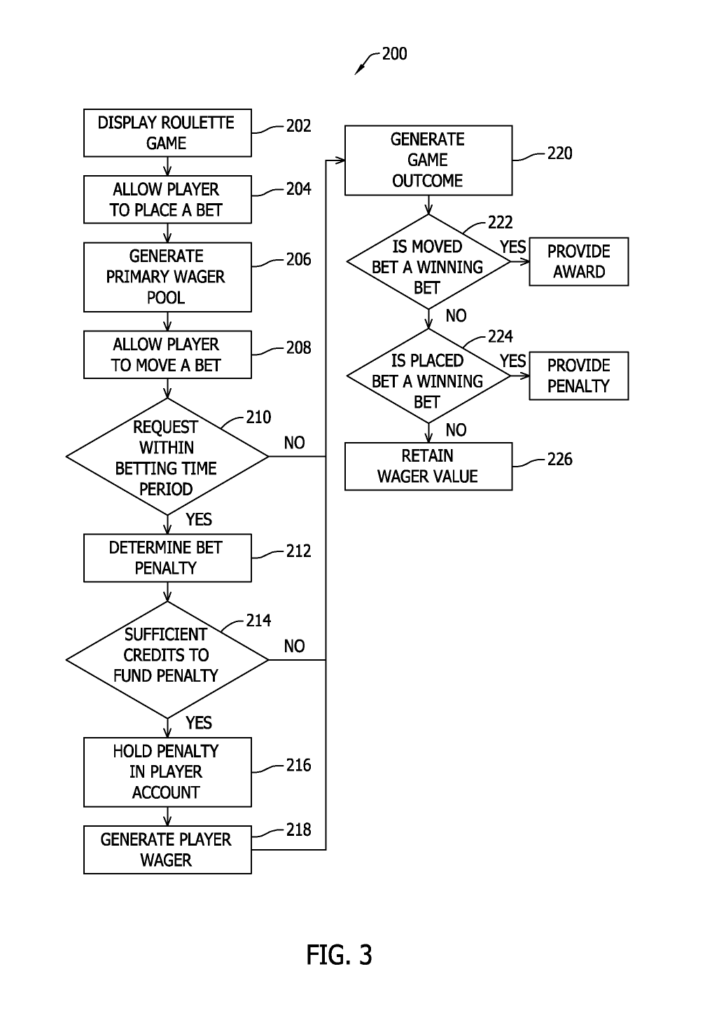

FIG. 3 is a flowchart of a method 200 that may be used with the system 10 for allowing a player to play a game via a user computing device 14. Each method step may be performed independently of, or in combination with, other method steps. Portions of the method 200 may be performed by any one of, or any combination of, the components of the system 10. FIGS. 4-6 are exemplary entertaining graphical displays of the roulette-type game 16 that may be played with the system 10. FIG. 7 is an exemplary entertaining graphical display of the roulette-type game 16 including a broadcast image of a live roulette table. In the illustrated embodiment, entertaining graphical displays for amusement purposes are presented by the user computing device 14 via the display device 32 (shown in FIG. 1) and may receive input (e.g., selections and/or entries) via the user input device 34 (shown in FIG. 1). For example, in one embodiment, a selection may be received via the user input device 34 of the user computing device 14 and may be transmitted by the user computing device 14 to the server system 12 via the network 22.

In the illustrated embodiment, in the method step 202, the gaming controller 36 receives a request from a player to play the roulette-type game 16 from a user computing device 14 and displays the game 16 on the display device 32 for play by the player. In one embodiment, the player may submit the request by accessing a website via the communications server 38. In another embodiment, the player may access a mobile website via the cellular network 24. In addition, in one embodiment, the method step 202 may include receiving, by the gaming controller 36, a unique user identifier to validate the request to display the roulette-type game 16. More specifically, the display module 58 may display a login screen (not shown) on the user computing device 14 to request the unique user identifier such as, for example, requesting a username and/or password. The gaming controller 36 may receive the unique user identifier and transmit a validation request including the user credentials to the player account server 40. The player account server 40 may compare the received unique user identifier with the collection of unique user identifier contained in the user profile program to validate the unique user identifier and responsively send a validation message to the gaming controller 36 if the received unique user identifier is included in the user profile program. Upon receiving the validation message from the player account server 40 the gaming controller 36 may display the game 16. In addition, in one embodiment, if the received user identifier is not included in the user profile program 56, the gaming controller 36 may prompt the user to establish a user account and/or display the game 16 without requiring the user to establish a user account and/or verify a user account. In addition, in one embodiment, method step 202 may also include receiving a wager from the player and/or receiving a request to purchase a play of the game with game credits from the corresponding user profile account.

In method step 202, the gaming controller 36 also displays a game screen 90 including the game 16 in response to the request received from the player via the user computing device 14. In the illustrated embodiment, the gaming controller 36 displays the roulette-type game 16. However, it should be noted that the gaming controller 36 may display any type of game upon which a player could make a wager and/or purchase a game play including, but not limited to a slot game, a blackjack game, a video poker game, or any type of game that enables the system 10 to function as described herein.

In the illustrated embodiment, during method step 202, the game module 66 displays the roulette-type game 16 game including a betting area 76, player account area 92, and a roulette wheel 74. The player account area 92 displays information associated with a player account including, but not limited to, an amount of game credits available in the financial account, a current wager value, a payout award associated with a wager, and/or a penalty amount associated with a wager. The roulette wheel 74 is displayed with a plurality of outcome symbols 78 orientated about a perimeter of the roulette wheel 74. Each outcome symbol 78 displayed with the roulette wheel 74 is indicative of a game outcome of the roulette-type game 16. The betting area 76 includes a plurality of game symbols 80 that are displayed in a grid 94. Each game symbol 80 is associated with one or more outcome symbols 78 to enable a player to place a wager on a game symbol 80 that is associated with one or more game outcomes. For example, in the illustrated embodiment, the game module 66 displays a first portion 96 of the grid 94 that includes a plurality of first game symbols 98. Each first game symbol 98 is associated with a corresponding outcome symbol 78. The display module 58 also displays a second portion 100 of the grid 94 that includes a plurality of second game symbols 102. Each second game symbol 102 is associated with a plurality of game outcome symbols 78. In the illustrated embodiment, the betting area 76 also includes a “Bet” selection area 104, a “Wager” selection area 106, and a “Move” selection area 108.

In method step 204, the betting module 64 allows a player to place one or more bets on the game. For example, in one embodiment, the betting module receives a request from one or more players to place one or more wagers on the game 16. The betting module 64 generates a primary wager associated with each request including a wager amount, an associated game outcome, and a corresponding payout value. For example, in the illustrated embodiment, a player selects the “Bet” selection area 104 to initiate a request to place a wager, selects a corresponding wager value displayed in the “Wager” selection area 106 that corresponds to an amount of game credits being wagered, and selects a game symbol 80 associated with a predetermined game outcome. The betting module 64 generates the primary wager as a function of the selected game symbol 80, the wager value, and the corresponding payout value. The credit module 62 withholds the wager value from the players account and displays the remaining account value on the player account area 92. In another embodiment, the “Bet” selection area 104 may indicate an amount of the current wager value being requested and allows the player to adjust the current wager value by moving a “sliding bar” 109 displayed in the “Bet” selection area 104.

In method step 206, the betting module 64 generates a set of primary wagers associated with each game outcome and corresponding game symbol 80. The set of primary wagers includes each primary wager received from one or more players associated with the corresponding game symbol 80. The betting module 64 stores the set of primary wagers in the primary wager selection table 54 contained in the database 44. In addition, during the game round, the betting module 64 determines a total primary wager value 111 equal to an amount of primary wagers placed on corresponding game symbol 80 and displays the total primary wager value 111 associated with the game symbol 80 in the betting area 76. The betting module 64 also dynamically updates the total primary wager value 111 as a function of each wager received on the game symbol 80 such that the total primary wager value 111 may change during the game round. In addition, the display module 58 displays one or more primary bet symbols 110 in the betting area 76. Each primary bet symbol 110 is indicative of each primary wager and is positioned with respect to the game symbol 80 corresponding to the primary wager. In one embodiment, the game module 66 may randomly generate a plurality primary wagers associated with a plurality of game outcomes and display the primary wagers in the betting area 76. In another embodiment, the game module 66 may generate one or more primary wagers as a function of wagers made during a previous round of the game 16. For example, the user profile account associated with the player may include a list of previous wagers made by the player. The betting module 64 may generate the list of primary wagers as a function of the list of previous wagers included in the associated user profile account.

In method step 208, the betting module 64 allows a player to move one or more of the placed bets. For example, in one embodiment, the betting module 64 receives a request from one or more players to place a modified wager as a function of one or more primary wagers, and generates a modified wager as a function of the received request. Moreover, the player may request to move a primary wager being displayed in the betting area 76 from a first game outcome to a second game outcome and select a wager amount associated with the modified wager. For example, the player may request to move a primary bet symbol 110 from a first game symbol 84 indicative of the first outcome to a second game symbol 86 indicative of a second game outcome that is different from the first game outcome. The betting module 64 generates a modified wager associated with each request including the selected wager amount, an associated second game outcome, and a corresponding payout value.

For example, in the illustrated embodiment, a player selects the “Move” selection area 108 to initiate a request to place a modified wager, selects a corresponding modified wager value displayed in the “Wager” selection area 106 that corresponds to an amount of game credits being wagered, selects a primary bet symbol 110 corresponding to the first game symbol 84 associated with a primary wager, and selects a second game symbol 86 associated with a second game outcome, and selects a wager value associated with the modified wager. The display module 58 moves the selected primary bet symbol 110, represented by arrow 112, from a position with respect to the first game symbol 84 to a position with respect to the selected second game symbol 86 based on the player's request. The display module 58 may also display a modified bet symbol 114 in the betting area 76 with respect to the selected second game symbol 86. The betting module 64 then generates a modified wager based on the selected second game symbol 86 that is indicative of the second game outcome and the selected modified wager value. In the illustrated embodiment, the selected primary wager is associated with a first payout value and the selected modified wager is associated with a second payout value that is different from the first payout value. In one embodiment, the “Move” selection area 108 may indicate an amount of the current modified wager value being requested and allow the player to adjust the modified wager value by moving a “sliding bar” 109 displayed in the “Move” selection area 108.

In the illustrated embodiment, the betting module 64 allows the player to select a modified wager value between a range between a predefined wager value and the total primary wager value 111 associated with the selected first game symbol 84. For example, upon receiving a request to generate a modified wager including a selected wager value, the betting module 64 determines if the selected wager value is less than or equal to the total primary wager value 111 associated with the selected first game symbol 84 and generates the modified wager if the requested wager value is less than or equal to the total primary wager value 111. The betting module 64 may also display a notification message to the player if the requested wager value is greater than the corresponding total primary wager value and/or less than a predefined wager value, and request the player to select a wager value that is within the range of wager values.

In method step 210, the game module 66 determines if the modified wager request is made within a predefined betting period. If the modified wager request is made within the betting period the gaming controller 36 proceeds to step 212 and determines a penalty associated with the requested modified wager. If the modified wager request is not made within the betting period, the gaming controller 36 proceeds to step 220 and determines an outcome of the game 16. The predefined betting period may be indicative of a period of time in which primary wagers and modified wagers may be made by the players prior to a game initiation event. The game module 66 allows players to place primary wagers and modified wagers during the betting period. The game initiation event may be, but is not limited to, a spinning of the roulette wheel 74 and/or any audio and/or visual indication to the players that is indicative of the end of the betting period. In the illustrated embodiment, the game module 66 determines the betting period to include 30 seconds prior to the spinning of the roulette wheel 74, and provides a notice to the players of the time elapsed within the betting period. In one embodiment, the betting period may also include a primary wagering period and a modified wagering period. During the primary wagering period, the game module 66 allows players to place primary wagers associated with the game 16. During the modified wagering period, the game module 66 allows the players to place modified wagers that are associated with one or more primary wagers made during the primary wager period. In another embodiment, primary wagers and modified wagers may be made during the modified wagering period. In one embodiment, the display module 58 may display a counter 113 that indicates the time remaining within the betting period.

In method step 212, the betting module 64 determines a penalty associated with the modified wager placed by the player as a function of the first outcome associated with the player selected primary wager. In the illustrated embodiment, the betting module 64 determines the payout award associated with the selected primary wager and determines the penalty as a function of the primary wager payout award and the modified wager value associated with the modified wager. For example, in one embodiment, the betting module 64 may determine the penalty to be equal to the modified wager value in game credits multiplied by the primary wager payout value. Alternatively, the betting module 64 may determine the penalty as a function of a predefined penalty value and/or any suitable penalty that enables the gaming controller 36 to function as described herein.

In method step 214, the betting module 64 determines if the player account includes sufficient game credits to fund the determined penalty. If the player account includes an amount of game credits equal to, or greater than, the determined penalty amount associated with the modified wager request, the gaming controller 36 proceeds to step 216 and holds the penalty amount from the player account and generates the modified wager. If the player account includes an amount of game credits that is less than the determined penalty amount, the gaming controller 36 does not generate the requested modified wager and proceeds to step 220 to generate the game outcome.

In method step 216, the credit module 62 displays the determined penalty amount associated with the modified wager request in the player account area 92 and holds the determined penalty amount from an amount of funds available in the player account for placing and/or moving additional wagers before displaying the outcome of the roulette-type game 16. The penalty amount is withheld from the player account until the wagers placed on the game outcome are resolved. By holding the determined penalty amount, the player is prevented from placing an amount of wagers that exceed funds required to cover all placed and moved wagers.

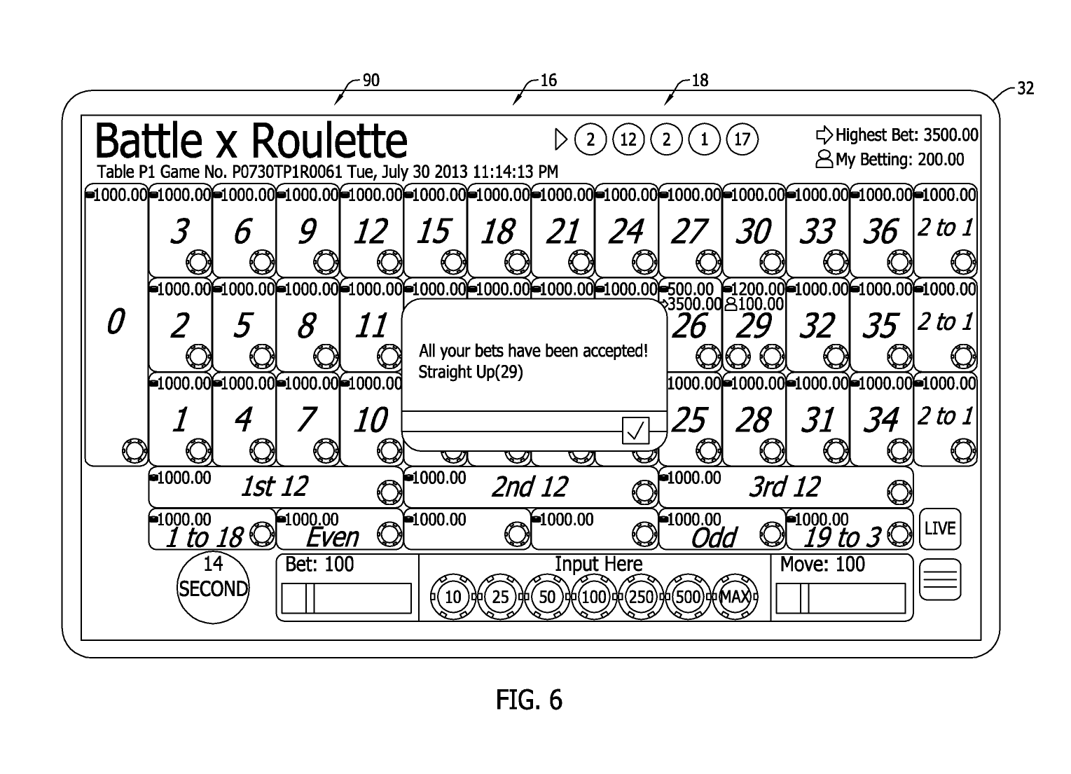

In method step 218, the betting module 64 generates the modified wager based on the received player's request and stores the information associated with the generated modified wager in the corresponding user profile account. The display module 58 also displays the modified bet symbol 114 with respect to the selected second game symbol 86. In one embodiment, the display module 58 may also display the modified wager value 116 with respect to the selected second game symbol 86 and display the associated penalty 118 with respect to the selected first game symbol 84. In addition, the display module 58 may display a notification message (shown in FIG. 6) to notify the player of the generated modified wager. In the illustrated embodiment, the betting module 64 determines an award associated with the generated modified wager. Moreover, the betting module 64 determines the award including a primary award and an enhanced award that is different than the primary award. The primary award is determined as a function of the second outcome associated with the selected second symbol 86, the modified wager value, and the second outcome payout value. In one embodiment, the primary award may be determined to be equal to the modified wager value multiplied by the second outcome payout value. In another embodiment, the primary award may be determined as a function of the second outcome and an additional wager value associated with the modified wager. In the illustrated embodiment, the enhanced award is equal to the sum of the modified wager value and the product of the modified wager value multiplied by the second outcome payout value. In another embodiment, the enhanced award may be equal to a multiplier of the primary award. In addition, the enhanced award may be, but is not limited to, a predefined amount of game credits, an award multiplier, additional wagers, a bonus game, and/or any suitable award.

In method step 220, the game module 66 displays an outcome of the roulette-type game and resolves the modified wager as a function of the game outcome. In one embodiment, the display module 58 displays a broadcast an image of a live roulette table game being played in a gaming property (as shown in FIG. 7). The game module 66 receives data indicative of the outcome of the live roulette game and resolves the wagers as a function of the received outcome. In another embodiment, the game module 66 randomly generates an outcome of the roulette-type game 16 and resolves the modified wager as a function of the randomly generated game outcome. The display module 58 spins and stops the roulette wheel 74 to display the generated game outcome. Moreover, the display module 58 begins spinning the roulette wheel 74 and spins the ball 82 within the roulette wheel 74. The display module 58 also slows and stops a movement of the ball 82 such that the ball 82 is stopped at a position adjacent to an outcome symbol 78 indicative of the randomly generated outcome.

In method step 222, the game module 66 determines if the modified wager includes a winning outcome as a function of the wagered second outcome and the generated game outcome, and responsively provides the award to the player if the modified wager outcome is a winning outcome. Moreover, the game module 66 determines if the generated game outcome includes the second outcome associated with the modified wager and responsively provides an award to the player if the generated game outcome includes the second outcome. In one embodiment, the game module 66 determines if the selected second game symbol 86 matches the selected outcome symbol 78 associated with the generated game outcome and provides an award if a match is determined.

If the modified wager outcome is not a winning outcome, the gaming controller 36 proceeds to method step 224 and determines if the selected primary wager outcome is a winning outcome and provides a penalty to the player if the primary wager outcome is a winning outcome. More specifically, in method step 224, the game module 66 determines if the generated game outcome includes the first outcome associated with the selected primary wager and responsively provides the penalty to the player if the generated game outcome includes the first outcome. If the penalty value has been deducted from the player account prior to displaying the game outcome, the game module 66 notifies the player of the assessed penalty and displays the player's account in the player account area 92. If the penalty value has not been previously deducted from the player account, the credit module 62 deducts the assessed penalty from the player account and displays the updated player account in the player account area 92.

If the generated game outcome does not include the primary wager outcome or the modified wager outcome, the game module 66 proceeds to step 226 and retains the wager associated with the modified wager and ends the game round. If the credit module 62 had previously deducted the penalty from the player account, the credit module returns the penalty amount to the player account and deducts the modified wager amount from the player account and displays the updated player account in the player account area 92.

In one embodiment, the gaming controller 36 may implement the method 200 according to the following examples.

### Example 1

The gaming controller 36 displays a primary wager placed on the number “20” (first outcome) with a total primary wager value equal to $1,000. The total primary wager value is indicative of the amount of primary wagers being placed on the number “20” outcome. The number “20” outcome includes a payout value equal to 1:35. A player selects the primary wager and moves the primary wager from number “20” to number “12” (second outcome) and requests a modified wager value equal to an amount up to the total primary wager value. For example, the player may move the primary bet symbol 110 from the number “20” game symbol 84 to the number “12” game symbol 86, and select a modified wager value equal to $100. The number “12” outcome includes a payout value equal to 1:35. The betting module 64 determines the award as a function of a primary award for placing the modified wager and an enhanced award for moving the primary wager. The primary award is equal to the modified wager value plus the product of the modified wager value multiplied by the second outcome payout value: $100+($100×35)=$3,600 primary award. The enhanced award is equal to the modified wager value multiplied by the second outcome payout value: $100×35=$3,500 enhanced award. The gaming controller 36 determines the award associated with the modified wager equal to the primary award plus the enhanced award: $3,600+$3,500=$7,100. The gaming controller 36 also determines the penalty as a function of the modified wager value and the first outcome payout value: $100×35=$3,500 penalty. The potential award provided to the player as a function of the modified wager may be represented in the following table.

| Game Outcome | | | |
|---|---|---|---|
| Primary wager | Modified Wager | Wager Result | Total Win/(Loss) |
| Loss | Win | Award | $7,100 |
| Loss | Loss | Wager Retained | ($100) |
| Win | Loss | Penalty | ($3,600) |

The first column represents the game outcome including a potential result of the primary wager and the modified wager. The second column represents the result of the modified wager associated with each determined outcome. The third column represents the value of the award/penalty provided to the player associated with the wager result. In the illustrated embodiment, if the modified wager outcome is determine to be a winning outcome, the gaming controller 36 provides the player an award equal to the sum of the primary award and the enhanced award: $3,600+$3,500=$7,100. If the modified wager outcome and the primary wager outcome are not winning outcomes, the gaming controller 36 retains the wager and deducts the wager amount from the player account: $100. If the primary wager outcome is determined to be a winning outcome, the gaming controller 36 assesses a penalty to the player equal to $3,600, and deducts the penalty amount from the player account.

### Example 2

The gaming controller 36 displays a primary wager placed on the number “20” (first outcome) with a total primary wager value equal to $1,000. The number “20” outcome includes a payout value equal to 1:35. A player selects the primary wager and moves the primary wager from number “20” to the “3^{rd} 12” symbol (second outcome), indicative of numbers 25-36, and requests a modified wager value in an amount equal to $100. For example, the player moves the primary bet symbol 110 from the number “20” game symbol 84 to the “3^{rd} 12” game symbol 86. The “3^{rd} 12” outcome includes a payout value equal to 1:2. The betting module 64 determines the primary award equal to modified wager value plus the product of the modified wager value multiplied by the second outcome payout value: $100+($100×2)=$300 primary award. The enhanced award is equal to the modified wager value multiplied by the second outcome payout value: $100×2=$400 enhanced award. The gaming controller 36 determines the award associated with the modified wager equal to the primary award plus the enhanced award: $300+$200=$500. The gaming controller 36 also determines the penalty as a function of the modified wager value and the first outcome payout value: $100×35=$3,500 penalty. The potential award provided to the player as a function of the modified wager may be represented in the following table.

| Game Outcome | | | |
|---|---|---|---|
| Primary wager | Modified Wager | Wager Result | Total Win/(Loss) |
| Loss | Win | Award | $500 |
| Loss | Loss | Wager Retained | ($100) |
| Win | Loss | Penalty | ($3,600) |

In the illustrated embodiment, if the modified wager outcome is determined to be a winning outcome, the gaming controller 36 provides the player an award equal to the sum of the primary award and the enhanced award, $300+$200=$500. If the modified wager outcome and the primary wager outcome are not winning outcomes, the gaming controller 36 retains the wager and deducts the wager amount from the player account: $100. If the primary wager outcome is determined to be a winning outcome, the gaming controller 36 assesses a penalty to the player equal to $3,600, and deducts the penalty amount from the player account.

### Example 3

The gaming controller 36 displays a primary wager placed on the “3^{rd} 12” (first outcome), indicative of numbers 25-36, with a total primary wager value equal to $1,000. The “3^{rd} 12” outcome includes a payout value equal to 1:2. A player selects the primary wager, moves the primary wager from “3^{rd} 12” to the number “25” (second outcome), and requests a modified wager value equal to $100. The number “25” outcome includes a payout value equal to 1:35. The betting module 64 determines the primary award equal to modified wager value plus the product of the modified wager value multiplied by the second outcome payout value: $100+($100×35)=$3,600 primary award. The enhanced award is equal to the modified wager value multiplied by the second outcome payout value: $100×35=$3,500 enhanced award. The gaming controller 36 also determines the award associated with the modified wager value equal to the primary award plus the enhanced award: $3,600+$3,500=$7,100. In the illustrated embodiment, the selected primary wager outcome “3^{rd} 12” also includes the modified wager outcome “25” such that a generated game outcome that includes a selection of the number “25” would result in a winning modified wager outcome and a winning primary wager outcome. In this example, the gaming controller 36 determines the penalty as a function of the modified wager value and the first outcome payout value: $100×2=$200 penalty. The potential award provided to the player as a function of the modified wager may be represented in the following table.

| Game Outcome | | | |
|---|---|---|---|
| Primary wager | Modified Wager | Wager Result | Total Win/(Loss) |
| Loss | Win | Award | $7,100 |
| Loss | Loss | Wager Retained | ($100) |
| Win | Win | Penalty | ($200) |

In the illustrated embodiment, if the modified wager outcome is determined to be a winning outcome, the gaming controller 36 provides the player an award equal to the sum of the primary award and the enhanced award, $3,600+$3,500=$7,100. If the modified wager outcome and the primary wager outcome are not winning outcomes, the gaming controller 36 retains the wager and deducts the wager amount from the player account, $100. If the primary wager outcome and the modified wager outcome are each determined to be a winning outcome, the gaming controller 36 assesses a penalty to the player equal to $200, and deducts the penalty amount from the player account. Many variations to the above described general play of a fall within the scope of the present invention.

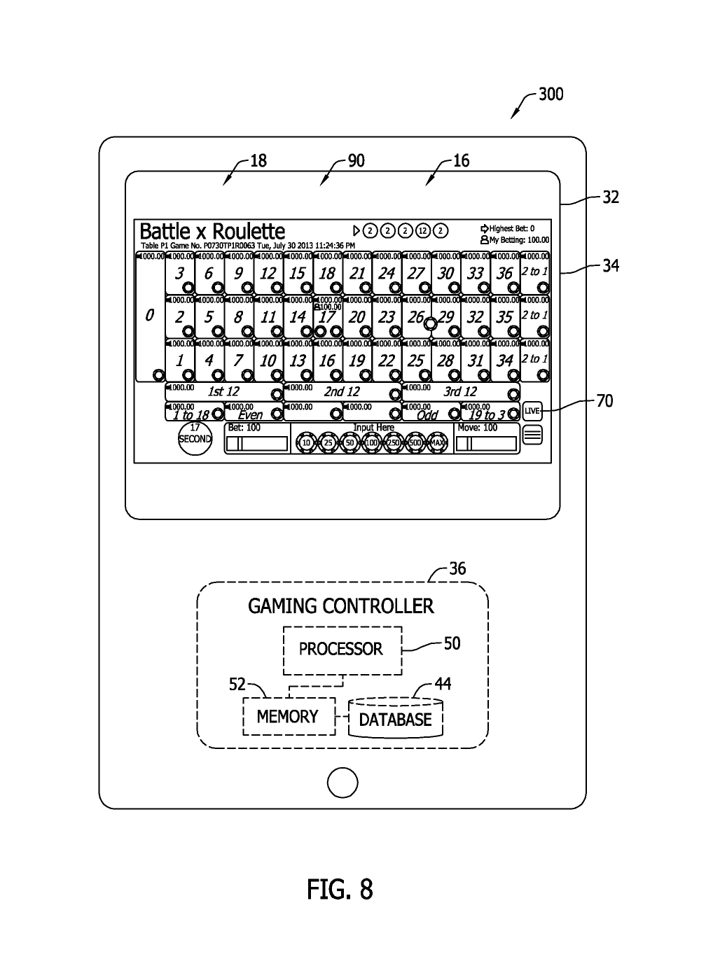

FIG. 8 is a schematic view of a gaming device 300 for allowing a player to play the roulette-type game 16, according to an embodiment of the invention. The gaming device 300 may be a smartphone, a personal computer, laptop, cell phone, tablet computer, smartphone/tablet computer hybrid, personal data assistant, and/or any suitable computing device that displays the graphical interfaces 18 and enables the user to play the roulette-type game 16. In the illustrated embodiment, the gaming device 300 includes the display device 32, the user input device 34, and the gaming controller 36 coupled to the display device 32 and the user input device 34.

The gaming controller 36 includes the processor 50, the memory device 52, and the database 44. The memory device 52 stores programs and information used by the processor 50 including, but not limited to, image data for producing images and/or screens on the display device 32, game indicia, symbol weights, paytables, and/or winning combination tables which represent relationships between combinations of random numbers, combinations of symbol matches and types of awards associated with the roulette-type game 16.

The processor 50 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the gaming controller 36 to store, retrieve, and/or execute instructions and/or data. The gaming controller 36 in particular executes a game program to implement the method 200 and thereby conducts a game in accordance with the embodiments described herein.

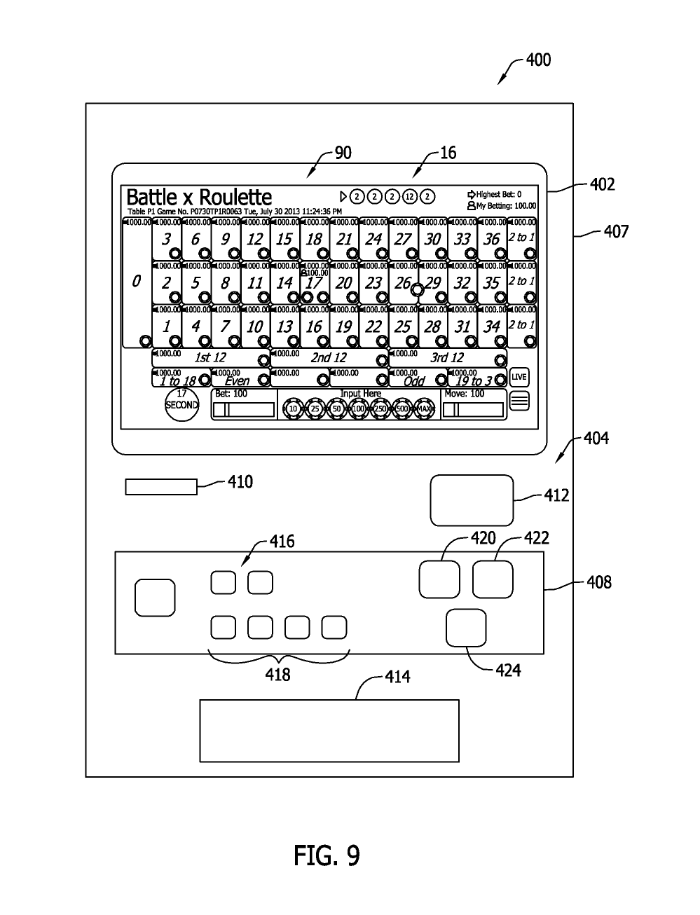

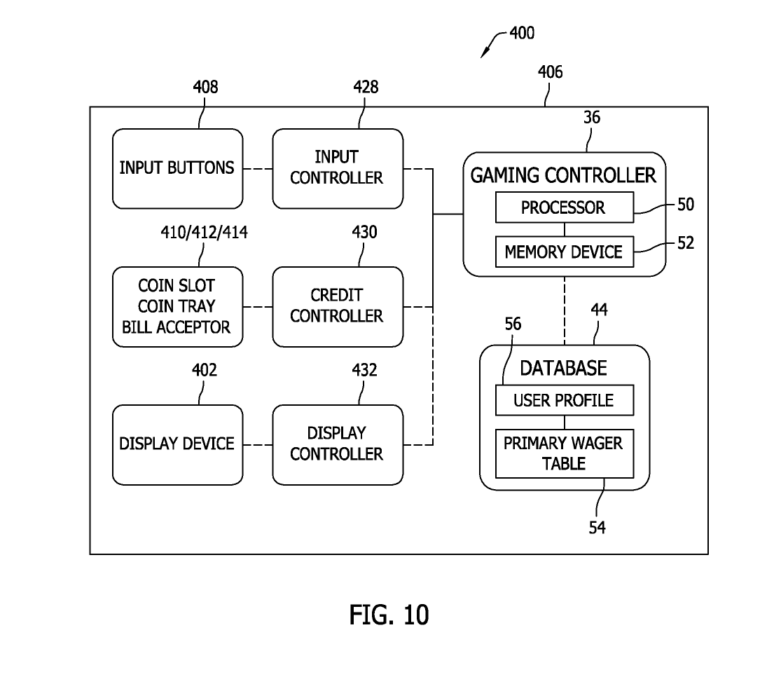

FIG. 9 is a schematic representation of a gaming machine 400 that may be used to allow a player to play the roulette-type game 16, according to an embodiment of the present invention. FIG. 10 is another schematic view of the gaming machine 400. A preferred embodiment of the present invention is a video gaming machine preferably installed in a casino. In the illustrated embodiment, the gaming machine 400 includes a display device 402 such as, for example display device 32 for displaying a plurality of games, a user input device 404 to enable a player to interface with the gaming machine 400, and a system controller 406 that is operatively coupled to the display device 402 and the user input device 404 to enable a player to play games displayed on the display device 402. The gaming machine 400 may also include a cabinet assembly 407 that is configured to support the display device 402, the user input device 404, and/or the system controller 406 from a supporting surface.

The display device 402 and the user input device 404 are coupled to the cabinet assembly 407 and are accessible by the player. In one embodiment, the system controller 406 is positioned within the cabinet assembly 407. Alternatively, the system controller 406 may be separated from the cabinet assembly 407, and connected to components of the gaming machine 400 through a network such as, for example, a local area network (LAN), a wide area network (WAN), dial-in-connections, cable modems, wireless modems, and/or special high-speed Integrated Services Digital Network (ISDN) lines.

In the illustrated embodiment, the display device 402 displays the game screen 90 (shown in FIGS. 4-7) including indicia and/or symbols for use in a game, e.g., symbols for a bingo game, cards used by a card game, roulette wheel and symbols used in a roulette game, and/or reels used in a reel game.

The user input device 404 includes a plurality of input buttons 408, a coin slot 410, a bill acceptor 412, and a coin tray 414 for dispensing coins to the player. In one embodiment, the input buttons 408 may include a plurality of BET switches 416 for inputting a wager on a game and selecting a number of rounds to be played during a gaming session, a plurality of selection switches 418 for allowing a player to select a plurality of game symbols, a CLEAR switch 420 for de-selecting player selected game symbols, a PAYOUT switch 422 for ending a gaming session and dispensing accumulated game credits to the player, and a start button, i.e., a SPIN switch 424 to initiate an output of a game. In addition, the user input device 404 may include, for example, a keyboard, a pointing device, a mouse, a stylus, a touch sensitive panel (e.g., a touch pad or a touch screen), a gyroscope, an accelerometer, a position detector, an audio input device, and/or any suitable input device that enables the player to interact with the gaming machine 400.

The coin slot 410 includes an opening that is configured to receive coins and/or tokens deposited by the player into the gaming machine 400. The gaming machine 400 converts a value of the coins and/or tokens to a corresponding amount of game credits that are used by the player to wager on games played on the gaming machine 400. The bill acceptor 412 includes an input and output device that is configured to accept a bill, a ticket, and/or a cash card into the gaming machine 400 to enable an amount of game credits associated with a monetary value of the bills, ticket, and/or cash card to be credited to the gaming machine 400.

Referring to FIG. 10, in the illustrated embodiment, the system controller 406 includes the gaming controller 36, the database 44, an input controller 428, a credit controller 430, and a display controller 432. The gaming controller 36 communicates to the database 44, the input controller 428, the credit controller 430, and the display controller 432, and executes various programs, and thereby controls other components of the gaming machine 400 according to player instructions and data accepted by the user input device 404. The gaming controller 36 in particular executes a game program to implement the method 200 and thereby conducts a game in accordance with the embodiments described herein. In one embodiment, the gaming controller 36 utilizes RAM to temporarily store programs and data necessary for the progress of the game, and EPROM to store, in advance, programs and data for controlling basic operation of the gaming machine 400, such as the booting operation thereof.

The credit controller 430 manages the amount of player's credits, which is equivalent to the amount of coins and bills counted and validated by the bill acceptor 412. The credit controller 430 converts a player's credits to coins, bills, or other monetary data by using the coin tray 414 and/or for use in dispensing a credit voucher via the bill acceptor 412.

The input controller 428 is coupled to the user input device 404 to monitor player selections received through the input buttons 408, and accept various instructions and data that a player enters through the input buttons 408.

The display controller 432 controls the display device 402 to display various images on screens preferably by using computer graphics and image data stored in the database 44. More specifically, the display module 58 controls the game symbols displayed in the game such as, for example, a roulette-type game 16 displayed on the display device 402 by using computer graphics and the image data.

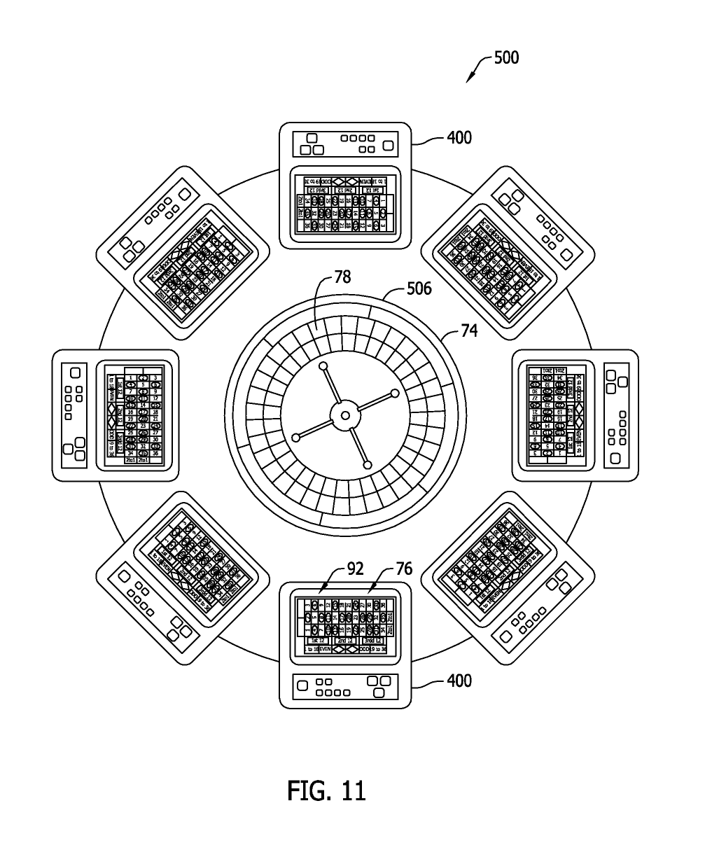

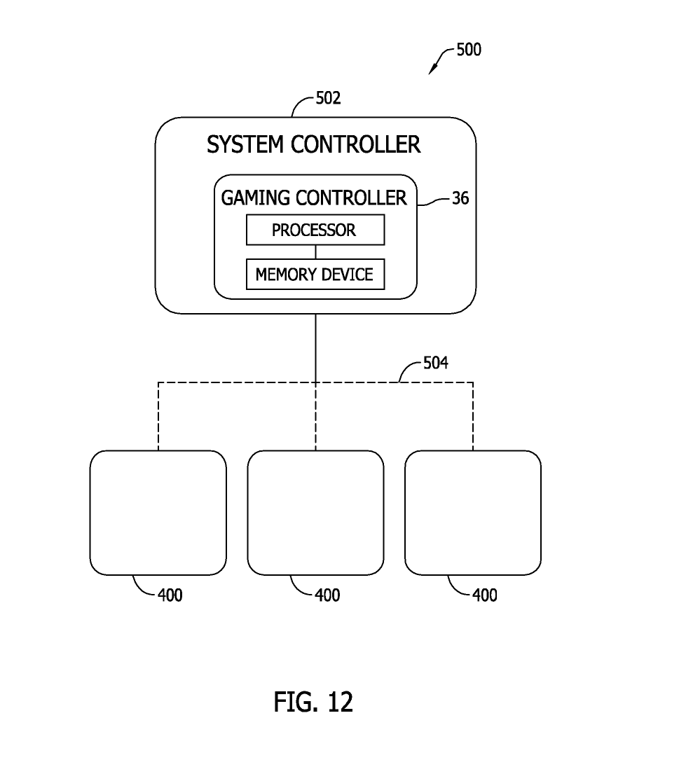

FIGS. 11 and 12 are schematic views of another system 500 for allowing a plurality of players to play the roulette-type game 16. The gaming system 500 includes a system controller 502 and one or more gaming machines 400 that are coupled to the system controller 502. In one embodiment, the system 500 includes a plurality of gaming machines 400 installed in a casino. In the illustrated embodiment, the system controller 502 is configured to perform all of the functions of the gaming controller 36 as described herein. The system controller 502 communicates with each gaming machine 400 for playing the game 16 on each gaming machine 400 based on user selection input received from each gaming machine 400.

In the illustrated embodiment, the gaming machines 400 and the system controller 502 are coupled in communication with a local area network (LAN) 504. Alternatively, the gaming machines 400 and the system controller 502 may be coupled via a network such as, for example, an Internet link, an intranet, a WAN, dial-in-connections, cable modems, wireless modems, and/or ISDN lines. In the illustrated embodiment, the gaming system 500 includes a plurality of gaming machines 400 that are oriented with respect to a central display 506. The central display 506 is coupled to the system controller 502 for displaying a portion of the game 16 on the central display 506. For example, during game play, the system controller 502 displays the outcome symbols 78 including the roulette wheel 74 on the central display 506 and displays the betting area 76 on each gaming machine 400. In addition, the system controller 502 may also display a player account area 92 on each gaming machine 400 that corresponds with player playing the associated gaming machine 400. During a round of the game, the system controller 502 receives one or more primary wagers from one or more gaming machines and generates the list of primary wagers from each received primary wager. The system controller 502 also displays each primary wager from the list of primary wagers on each gaming machine and allows each player to request a different modified wager from the displayed pool of primary wagers. Thus allowing each player at each gaming machine to place primary wagers and modified wagers associated with the game outcome that is displayed on the central display 506. The system controller 502 may also generate the game outcome, display the game outcome on the central display 506, and resolve each wager made during the game round as a function of the wager received and the generated game outcome.

In one embodiment, the system controller 502 may be implemented by one of the gaming controllers 36 associated with a gaming machines 400. In still another embodiment, the system controller 502 may be located remotely with respect to gaming machines 400, or within one of the gaming device cabinet assemblies 407 (shown in FIG. 6).

The above-described systems and methods overcome at least some disadvantages of known systems by allowing a player to place a wager having a payout that is determined as a function of a plurality of possible game outcomes. The system receives a request from a player to place a wager on the roulette-type game that is associated with a first outcome and a second outcome, randomly generates an outcome of the game, and resolves the player's wager as a function of the first outcome, the second outcome, and the generated game outcome. More specifically, the system provides a penalty to the player if the generated outcome matches the first outcome and provides an award to the player if the generated game outcome matches the second outcome. By providing a gaming device and method that generates a wager that is dependant a plurality of game outcomes, the probability of achieving an award is increased and the burden imposed on game designers is significantly reduced. In addition, by generating a pool of primary wagers and displaying each of the primary wagers on a game screen, the player can more easily view the available wagering options over known gaming systems. Thus, the player's expectation of achieving a winning outcome is increased and the amount of time that the game is played by the players patrons of a gaming establishment is thereby increased, thus increasing an overall profitability of the gaming establishment and reducing the burden on the game designers.

Exemplary embodiments of a system and method of allowing a player to play a roulette-type game that allows a player to place a wager on a plurality of game outcomes via a mobile computing device are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other wagering applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A method for allowing players to play a matching-type game with a gaming device, the gaming device including a controller in communication with a display device and a user input device, the method comprising the steps of:
displaying, on the display device, a matching-type game including a plurality of game symbols being displayed on a game screen, each game symbol being indicative of a plurality of game outcomes;
receiving a request from a player to place a wager on the game, the wager being associated with a first outcome and a second outcome;
responsively generating a modified wager as a function of the received request;
randomly generating an outcome of the matching-type game; and
resolving the modified wager as a function of the first outcome, the second outcome, and the generated game outcome.

2. A method in accordance with claim 1, further comprising the steps of:
providing a penalty to the player if the generated outcome is equal to the first outcome; and
providing an award to the player if the generated game outcome is equal to the second outcome.

3. A method in accordance with claim 1, further comprising the steps of:
displaying a plurality of primary wagers on the game screen, each of the plurality of primary wagers being associated with a game outcome;
receiving a request from a player indicative of a player's selection of at least one primary wager of the plurality of primary wagers, the at least one primary wager being associated with the first outcome; and
responsively generating the modified wager as a function of the selected primary wager, the modified wager being associated with the second outcome.

4. A method in accordance with claim 3, further comprising the steps of:
initiating a predefined period of time prior to generating the game outcome; and
allowing the player to select the primary wager during the predefined period of time.

5. A method in accordance with claim 3, wherein the selected primary wager includes a first payout value, the modified wager includes a second payout value that is different than the first payout value.

6. A method in accordance with claim 3, wherein each primary wager includes a first wager value, the method further comprising the step of allowing the player to request a modified wager having a second wager value between a range equal to a minimum wager value and the first wager value.

7. A method in accordance with claim 3, further comprises the step of providing an award to the player if the generated outcome is equal to the second outcome, the award determined as a function of the second payout value.

8. A method in accordance with claim 3, further comprises the step of providing a penalty to the player if the generated outcome is equal to the first outcome, the penalty determined as a function of the first payout value.

9. A method in accordance with claim 1, further comprising the steps of:
receiving a player request to generate the modified wager; and
determining a penalty value associated with the modified wager, the penalty value being equal to an amount of game credits.

10. A method in accordance with claim 9, further comprising the steps of:
determining an amount of game credits available in a player account associated with the player; and
generating the modified wager if the determined amount of game credits is at least equal to the penalty value.

11. A method in accordance with claim 10, further comprising the step of holding an amount of game credits from the player account equal to the penalty value upon generating the modified wager.

12. A method in accordance with claim 3, further comprising the steps:
displaying a primary bet symbol on the game screen indicative of the primary wager, the primary bet symbol being displayed in a first position associated with a first symbol;
receiving a player request to generate the modified wager; and
moving the primary bet symbol from the first position to a second position associated with a second symbol indicative of the modified wager in response to the received player request.

13. A method in accordance with claim 3, further comprising the steps of:
receiving a signal indicative of a plurality of player initiated wagers being requested by plurality of players;
generating a set of primary wagers as a function of the plurality of player initiated wagers; and
displaying the set of primary wagers on the game screen.

14. A method in accordance with claim 13, further comprising the step of:
allowing a player to select at least one primary wager from the set of primary wagers; and
generating the modified wager associated with each selected primary wager.

15. A gaming device for allowing a player to player a matching-type game, comprising:
a display device for displaying the matching-type game including a plurality of game symbols being displayed on a game screen, each game symbol being indicative of a plurality of game outcomes;
a user input device adapted to receive a signal indicative of a player's selection; and
a controller in communication with the display device and the user input device, the controller for receiving a request from a player to place a wager associated with the game, the wager being associated with a first game outcome and a second game outcome, for responsively generating a modified wager as a function of the received request, randomly generating an outcome of the matching-type game, and resolving the modified wager as a function of the first outcome, the second outcome, and the generated game outcome.

16. A gaming device in accordance with claim 15, the controller for providing a penalty to the player if the generated outcome is equal to the first outcome and providing an award to the player if the generated game outcome is equal to the second outcome.

17. A gaming device in accordance with claim 15, the controller for displaying a plurality of primary wagers on the game screen, each of the plurality of primary wagers being associated with a game outcome, receiving a request from a player indicative of a player's selection of at least one primary wager of the plurality of primary wagers, the at least one primary wager being associated with the first outcome, and responsively generating the modified wager as a function of the selected primary wager, the modified wager being associated with the second outcome.

18. A gaming device in accordance with claim 17, the controller for initiating a predefined period of time prior to generating the game outcome and allowing the player to select the primary wager during the predefined period of time.

19. A gaming device in accordance with claim 17, wherein the selected primary wager includes a first payout value, the modified wager includes a second payout value that is different than the first payout value.

20. A gaming device in accordance with claim 17, wherein each primary wager includes a first wager value, the controller for allowing the player to request a modified wager having a second wager value between a range equal to a minimum wager value and the first wager value.

21. A gaming device in accordance with claim 17, the controller for providing an award to the player if the generated outcome is equal to the second outcome, the award determined as a function of the second payout value.

22. A gaming device in accordance with claim 17, the controller for providing a penalty to the player if the generated outcome is equal to the first outcome, the penalty determined as a function of the first payout value.

23. A gaming device in accordance with claim 15, the controller for receiving a player request to generate the modified wager and determining a penalty value associated with the modified wager, the penalty value being equal to an amount of game credits.

24. A gaming device in accordance with claim 23, the controller for determining an amount of game credits available in a player account associated with the player and generating the modified wager if the determined amount of game credits is at least equal to the penalty value.

25. A gaming device in accordance with claim 24, the controller for holding an amount of game credits from the player account equal to the penalty value upon generating the modified wager.

26. A gaming device in accordance with claim 17, the controller for displaying a primary bet symbol on the game screen indicative of the primary wager, the primary bet symbol being displayed in a first position associated with a first symbol, for receiving a player request to generate the modified wager and moving the primary bet symbol from the first position to a second position associated with a second symbol indicative of the modified wager in response to the received player request.

27. A gaming device in accordance with claim 17, the controller for receiving a signal indicative of a plurality of player initiated wagers being requested by plurality of players, generating a set of primary wagers as a function of the plurality of player initiated wagers, and displaying the set of primary wagers on the game screen.

28. A gaming device in accordance with claim 27, the controller for allowing a player to select at least one primary wager from the set of primary wagers and generating the modified wager associated with each selected primary wager.

29. One or more non-transitory computer-readable storage media, having computer-executable instructions embodied thereon, wherein when executed by at least one processor, the computer-executable instructions cause the processor to:
display, on the display device, a roulette-type game including a plurality of game symbols being displayed on a game screen, each game symbol being indicative of a plurality of game outcomes;
receive a request from a player to place a wager on the game, the wager being associated with a first outcome and a second outcome;
responsively generate a modified wager as a function of the received request;
randomly generate an outcome of the roulette-type game; and
resolve the modified wager as a function of the first outcome, the second outcome, and the generated game outcome.

30. The one or more computer-readable storage media according to claim 29, wherein when executed by at least one processor, the computer-executable instructions cause the processor to:
provide a penalty to the player if the generated outcome is equal to the first outcome; and
provide an award to the player if the generated game outcome is equal to the second outcome.

31. The one or more computer-readable storage media according to claim 29, wherein when executed by at least one processor, the computer-executable instructions cause the processor to:
display a plurality of primary wagers on the game screen, each of the plurality of primary wagers being associated with a game outcome;
receive a request from a player indicative of a player's selection of at least one primary wager of the plurality of primary wagers, the at least one primary wager being associated with the first outcome; and
responsively generate the modified wager as a function of the selected primary wager, the modified wager being associated with the second outcome.

32. The one or more computer-readable storage media according to claim 31, wherein when executed by at least one processor, the computer-executable instructions cause the processor to:
initiate a predefined period of time prior to generating the game outcome; and
allow the player to select the primary wager during the predefined period of time.

33. The one or more computer-readable storage media according to claim 31, wherein the selected primary wager includes a first payout value, the modified wager includes a second payout value that is different than the first payout value.

34. The one or more computer-readable storage media according to claim 31, wherein each primary wager includes a first wager value, the computer-executable instructions cause the processor to allow the player to request a modified wager having a second wager value between a range equal to a minimum wager value and the first wager value.

35. The one or more computer-readable storage media according to claim 31, wherein when executed by at least one processor, the computer-executable instructions cause the processor to provide an award to the player if the generated outcome is equal to the second outcome, the award determined as a function of the second payout value.

36. The one or more computer-readable storage media according to claim 31, wherein when executed by at least one processor, the computer-executable instructions cause the processor to provide a penalty to the player if the generated outcome is equal to the first outcome, the penalty determined as a function of the first payout value.

37. The one or more computer-readable storage media according to claim 29, wherein when executed by at least one processor, the computer-executable instructions cause the processor to:
receive a player request to generate the modified wager; and
determine a penalty value associated with the modified wager, the penalty value being equal to an amount of game credits.

38. The one or more computer-readable storage media according to claim 37, wherein when executed by at least one processor, the computer-executable instructions cause the processor to:
determine an amount of game credits available in a player account associated with the player; and
generate the modified wager if the determined amount of game credits is at least equal to the penalty value.

39. The one or more computer-readable storage media according to claim 38, wherein when executed by at least one processor, the computer-executable instructions cause the processor to hold an amount of game credits from the player account equal to the penalty value upon generating the modified wager.

40. The one or more computer-readable storage media according to claim 31, wherein when executed by at least one processor, the computer-executable instructions cause the processor to:
display a primary bet symbol on the game screen indicative of the primary wager, the primary bet symbol being displayed in a first position associated with a first symbol;
receive a player request to generate the modified wager; and
move the primary bet symbol from the first position to a second position associated with a second symbol indicative of the modified wager in response to the received player request.

41. The one or more computer-readable storage media according to claim 31, wherein when executed by at least one processor, the computer-executable instructions cause the processor to:
receive a signal indicative of a plurality of player initiated wagers being requested by plurality of players;
generate a set of primary wagers as a function of the plurality of player initiated wagers; and
display the set of primary wagers on the game screen.

42. The one or more computer-readable storage media according to claim 41, wherein when executed by at least one processor, the computer-executable instructions cause the processor to:
allow a player to select at least one primary wager from the set of primary wagers; and
generate the modified wager associated with each selected primary wager.
